(19) United States
(12) Patent Application Publication
(10) Pub. No.: US 2018/0019770 A1
(43) Pub. Date: Jan. 18, 2018

(54) Contactless Transmission Coupler for Data Networks

(71) Applicant: TE Connectivity Germany GmbH, Bensheim (DE)

(72) Inventors: Felix Lange, Darmstadt (DE); Francisco Benito Lopez, Lautertal (DE); Holger Albrecht, Obernburg (DE); Michael Schambach, Dortmund (DE)

(73) Assignee: TE Connectivity Germany GmbH, Bensheim (DE)

(21) Appl. No.: 15/652,844

(22) Filed: Jul. 18, 2017

(30) Foreign Application Priority Data
Jul. 18, 2016 (DE) 102016213076.5

(51) Int. Cl. H04B 1/04; H04B 1/40; H04L 1/00; H04B 1/18; H04L 5/14

(52) U.S. Cl. CPC H04B 1/0458; H04L 1/0028; H04B 1/18; H04B 1/40; H04L 5/14

(57) ABSTRACT

A transmitter for a contactless transmission coupler transmitting data of a wired data network comprises an input, a converter, a modulator, a high-frequency step, and an antenna. The input receives a data signal. The converter is connected to the input, receives the data signal from the input, and converts the data signal into a sequence of bits representing a physical layer of a network protocol employed on the wired data network. The modulator is connected to the converter, receives the sequence of bits from the converter, and modulates a transmission signal with the sequence of bits. The high-frequency step is connected to the modulator, receives the transmission signal from the modulator, and generates a high-frequency signal by shifting the transmission signal into a high-frequency band. The antenna is connected to the high-frequency step, receives the high-frequency signal from the high-frequency step, and emits the high-frequency signal.

### CROSS-REFERENCE TO RELATED APPLICATION

This application claims the benefit of the filing date under 35 U.S.C. §119(a)-(d) of German Patent Application No. 102016213076.5, filed on Jul. 18, 2016.

### FIELD OF THE INVENTION

The present invention relates to a data transmission coupler and, more particularly, to a contactless data transmission coupler.

### BACKGROUND

The use of contactless couplers instead of cable or plug connections is known and can overcome some of the mechanical and electrical problems which accompany conventional cable or plug connections such as lack of flexibility, poor electrical reliability, or insufficient protection from environmental influences. Known contactless couplers consist of a transmitter and a receiver which transmit electromagnetic signals such as optical signals, radio signals, or form an inductive coupling over short distances. The data to be transmitted is first received by the transmitter in the form of an electrical data signal, decoded, and converted into the signal used for coupling. This signal is detected at the receiver and converted back into the original electrical data signal. These processing steps are unavoidably connected to a delay and a restriction of the bandwidth.

A contactless electromagnetic replacement for wired standard interfaces (such as universal serial bus, USB, for example) is disclosed in WO 2013/130486 A1 in which an electrical signaling state of a first USB device is transformed into an electromagnetic signal and is transmitted to a receiver of a second USB device via a contactless connection. There, the electromagnetic signal is converted back into an electrical signal which reproduces the original signaling state of the first USB device at the second USB device. If the time and electrical requirements on the electrical signal which are prescribed by the interface standard are followed, the contactless connection gives the impression that the second USB device is directly physically connected to the first USB device.

In order to be able to abide by the time requirements for the electrical signal to be transmitted, an appropriate bandwidth is necessary for the electromagnetic coupling signal. The above-mentioned contactless replacement uses a radio signal in the EHF (extremely high frequency) in the range from 30 to 300 GHz. The use of such high frequencies has, alongside the associated structural complications, the disadvantage that the coupling signal is exposed to a strong dampening through various materials, in particular water vapor. The reliability in use in an industrial environment can be impaired as a result.

A contactless Ethernet connection with a bidirectional converter is known from WO 2009/021025 A2. The transmission of the Ethernet signal takes place in the baseband with the aid of an inductive coupler. The use of an inductive coupling is, however, problematic in connection with high transmission rates.

Radio networks are also known in the prior art for wireless data transmission, for example WLAN (wireless local area network) which is known from the family of IEEE-802.11 standards. Such radio networks are, however, unsuitable for use under real-time requirements due to the lack of transmission security and the high (and unpredictable) latencies. None of the contactless couplers of the prior art can satisfy real-time requirements of industrial Ethernet protocols.

### SUMMARY

A transmitter for a contactless transmission coupler transmitting data of a wired data network according to the invention comprises an input, a converter, a modulator, a high-frequency step, and an antenna. The input receives a data signal. The converter is connected to the input, receives the data signal from the input, and converts the data signal into a sequence of bits representing a physical layer of a network protocol employed on the wired data network. The modulator is connected to the converter, receives the sequence of bits from the converter, and modulates a transmission signal with the sequence of bits. The high-frequency step is connected to the modulator, receives the transmission signal from the modulator, and generates a high-frequency signal by shifting the transmission signal into a high-frequency band. The antenna is connected to the high-frequency step, receives the high-frequency signal from the high-frequency step, and emits the high-frequency signal.

### BRIEF DESCRIPTION OF THE DRAWINGS

The invention will now be described by way of example with reference to the accompanying Figures, of which:

FIG. 1 is a block diagram of a contactless transmission coupler according to an embodiment of the invention with a transmitter and a receiver;

FIG. 2 is a block diagram of a contactless transmission coupler according to another embodiment of the invention as a transceiver;

FIG. 3 is a block diagram of a contactless transmission coupler according to another embodiment of the invention; and

FIG. 4 is a block diagram of a contactless transmission coupler according to another embodiment of the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

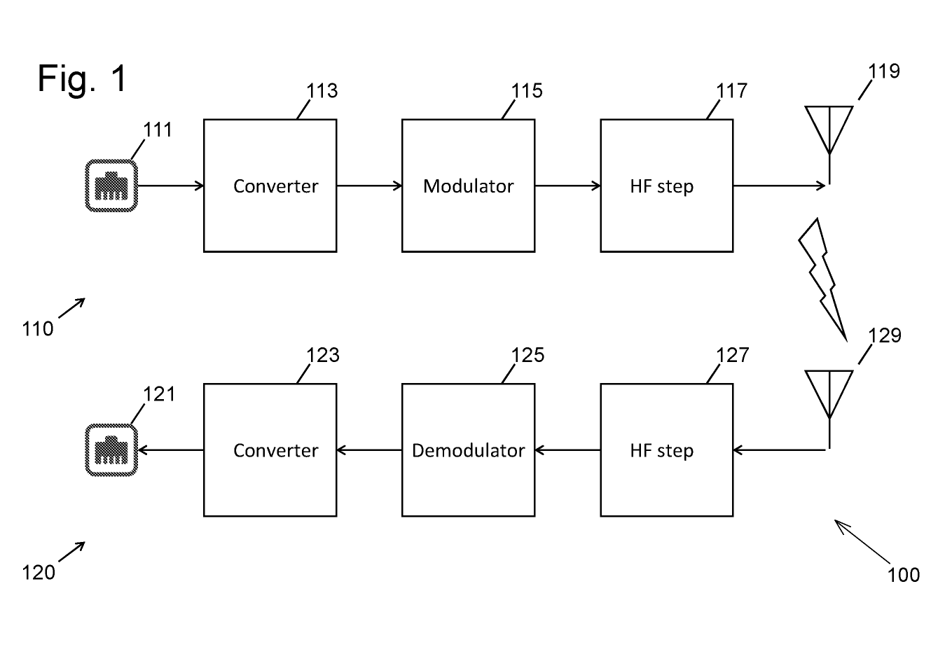

A contactless transmission coupler 100 according to the invention is shown in FIG. 1 and includes a transmitter 110 and a receiver 120.

The transmitter 110 receives, via an input 111, an Ethernet signal which is transformed into a sequence of bits by a converter 113, with the sequence of bits corresponding to the data which is transmitted on the bit transmission layer (PHY) of the Ethernet protocol. The converter 113 can be a conventional Ethernet PHY component which detects the bits transmitted by the (analogue) Ethernet signal adjacent to its input and provides them as a defined logic signal at the output. The converter 113 converts a line code, for example 4B5B code at Fast Ethernet 100BASE-TX, used on a physical transmission medium such as an Ethernet cable into the user data transmitted on the physical layer.

The bit sequence output by the converter 113 is successively, for example bit by bit or byte by byte or in another suitable number of bits per transmission, passed on to the modulator 115. The modular 115 converts the bit sequence directly without buffering or intermediately storing into a modulated transmission signal. Any suitable method can be employed for modulation including the known quadrature amplitude modulation (QAM), such as, for example, 4-QAM, 16-QAM, 64-QAM, 256-QAM, etc. The modulated transmission signal is converted into a radio signal in a high-frequency step 117 by shifting the transmission signal into a high-frequency band and is emitted via the antenna 119.

The successive transfer of the detected bit sequence to the modulator 115 takes place such that a sufficient number of bits are always passed on to the modulator 115 as are required to generate a symbol of the transmission signal. Each symbol of the transmission signal is essentially transmitted as soon as the appropriate number of bits has reached the physical layer—and not only after an entire packet or an entire frame of the employed transmission protocol has been received. In the case of 4-QAM, this is 2 bits per symbol, in the case of 16-QAM it is 4 bits, etc. The number of bits per symbol is significantly lower than the number of bits per frame or packet of the transmission protocol employed. For example, Ethernet packets have a minimum length of 72 bytes×8 bits/bytes=576 bits. As a result of the data of the physical layer being transmitted virtually bit-by-bit and not frame-by-frame or packet-by-packet, a correspondingly short latency can be ensured.

At the receiver 120 side, the radio signal emitted from the antenna 119 of the transmitter 110 is received via the antenna 129 and is processed in a high-frequency step 127 and fed to a demodulator 125. The high-frequency step 127 of the receiver 120 amplifies the received radio signal and mixes it down into an intermediate frequency band. A demodulator 125 converts the symbols used for transmission back into a sequence of digital bits. This bit sequence is converted by the converter 123 (Ethernet PHY) into the line code used on the physical transmission medium (Ethernet cable). The thus-generated Ethernet signal is provided at the output 121.

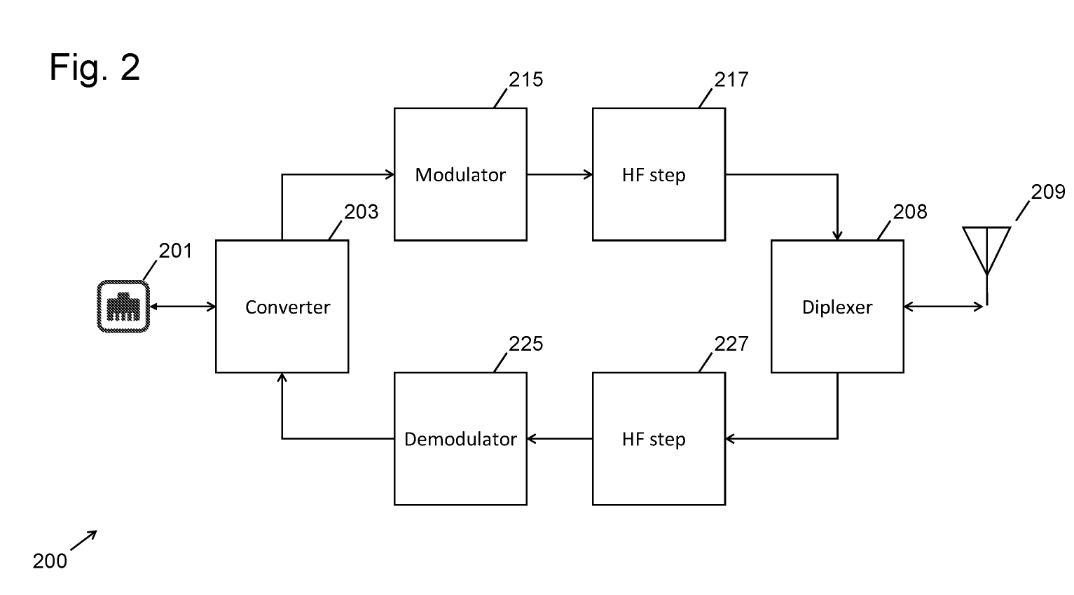

A contactless transmission coupler 200 according to the invention is shown in FIG. 2 which is a transceiver with combined transmission and receiving capabilities. The contactless transmission coupler 200 is capable of performing contactless bidirectional data transmission with an identical contactless transmission coupler 200.

The network connection 201 shown in FIG. 2 connects the contactless transmission coupler 200 to a wired data network such as an Ethernet cable. The converter 203, for example an Ethernet PHY as similarly described above, ensures the bidirectional conversion of the line code employed on the Ethernet cable into the bits transmitted on the physical layer. In transmission operation, these bits, as explained above, are converted by the modulator 215 into a transmission signal which is converted into a radio signal with the aid of the HF step 217 of the transmission branch. The HF radio signal is fed to the antenna 209 via a diplexer 208. In receiving operation, the radio signal received by the antenna 209 is forwarded to the HF step 227 of the receiving branch via the diplexer 208, is suitably amplified and converted into an intermediate frequency signal, and finally demodulated by the demodulator 225. The demodulated bit sequence is converted into line codes by the converter 203 and output at network connection 201.

The contactless transmission coupler 200 is capable of a full-duplex operation such that data can be transmitted and received simultaneously; separate frequency bands are used for the transmitting and receiving. The pair of transmission couplers 200 employed for one transmission path must be accordingly coordinated with one another; while one coupler 200 transmits in the first band and receives in the second band, the second coupler 200 must transmit in the second band and receive in the first band. The frequency of the transmission band and the receiving band of the transmission coupler 200 are both configurable during operation. The contactless transmission couplers 200 use the license-free ISM bands (Industrial, Scientific and Medical) for data transmission. In an embodiment, the two bands at 2.4 GHz and 5.8 GHz are used because numerous HF components (filters etc.) are already commercially available at such frequencies; the band at 2.4 GHz can be used for the transmission in one direction and the band at 5.8 GHz can be used for the transmission in the opposite direction. Due to the modulation employed according to the invention of the sequence of bits on the physical layer, the bandwidth provided by these bands is sufficient even for the transmission of Fast Ethernet signals.

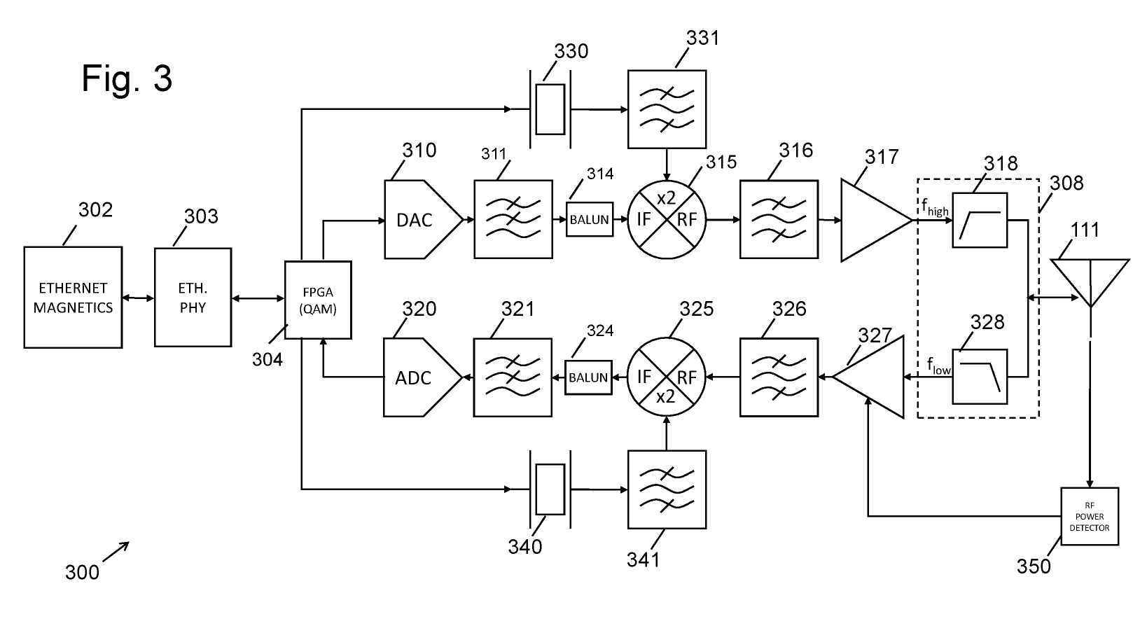

A contactless coupler 300 according to the invention for full-duplex operation is shown in FIG. 3. The contactless coupler 300 is designed for use as a Fast Ethernet coupler using the 5.2 GHz and 5.8 GHz bands.

As shown in FIG. 3, the Ethernet is connected via a filter 302 (“Ethernet Magentics”) to a conventional Ethernet physical layer transceiver 303 (“Ethernet PHY”), which in turn is coupled to a logic circuit 304 (FPGA, Field Programmable Gate Array). The logic circuit 304 is responsible for scheduling, modulation, and clock generation. Data which has been received on the physical layer by the Ethernet PHY 303 is quadrature-amplitude-modulated by the logic circuit 304 and passed onto a digital/analogue converter 310 for conversion into corresponding analogue signals. After renewed filtering through a first low-pass filter 311 and removal of a common-mode part by a first balun 314, the thus-generated transmission signal is converted, via a first mixer 315 and a first bandpass filter 316, into a HF signal in the 5.8 GHz band. The first low-pass filter 311 has a pass range of 0-100 MHz and the first bandpass filter 316 has a pass range of 5.8 GHz+/−0.75 GHz. The control frequency for the first mixer 315 is generated by the FPGA 304, a first oscillator 330 and a second bandpass filter 331 with a pass range of 2.8625 GHz+/−14 MHz. The HF signal is amplified in a first amplifier 317 and is output to a 5 GHz broadband antenna via a diplexer 308 with a high-pass filter 318.

In receiving operation, a radio signal received by a broadband antenna 309 is applied, via the diplexer 308 and the deep-pass filter 328, to a second amplifier 327 which has a variable amplification factor. The amplification factor is controlled via a power detector 350. The result is filtered through a third bandpass filter 326 and is transformed into the intermediate frequency band via the second mixer 325. The third bandpass filter 326 has a pass range 5.2 GHz+/−0.05 MHz. The control frequency for the second mixer 325 is generated by the FPGA 304, a second oscillator 340 and a fourth bandpass filter 341 with a pass range of 2.575 GHz+/−25 MHz. After removal of the common-mode part by a second balun 324 and low-pass filtering by a second low-pass filter 321 has been carried out, the receiving signal is digitized in the analogue/digital converter 320 and demodulated in the FPGA 304. The second low-pass filter 321 has a pass range of 0-100 MHz. The data bits obtained as a result are delivered to the Ethernet PHY 303 which converts this into a corresponding (analogue) Ethernet-Signal and outputs it to the data network via the filter 302.

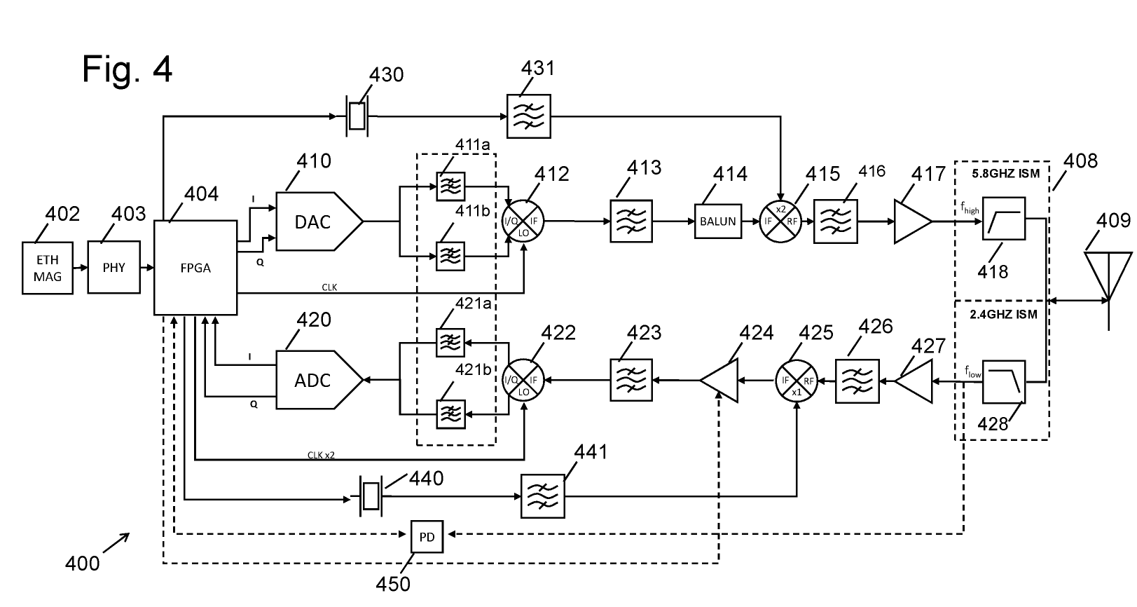

A contactless coupler 400 according to the invention for full-duplex operation is shown in FIG. 4. The contactless coupler 400 is designed for use as a Fast Ethernet coupler using the 2.4 GHz and 5.8 GHz bands. The contactless coupler 400 is similar to the contactless coupler 300, and similar elements have similar reference numbers.

In contrast to FIG. 3, in the architecture of the contactless coupler 400 in FIG. 4 additional mixers 412 and 422 are provided in an intermediate frequency (IF) step in order to ensure a correct demodulation even under bad reception conditions. Furthermore, the 2.4 GHz band is used instead of the 5.2 GHz band for one transmission channel in order to guarantee a safe channel separation; ready-made filter components are available inexpensively for these bands. The amplification control has been shifted from the HF step into the IF because amplifiers with a variable amplification factor are not available for the 5 GHz region or are extremely expensive.

As similarly described above with reference to FIG. 3, in the architecture of FIG. 4 the Ethernet is connected via a filter 402 to a conventional Ethernet PHY 403 which in turn is coupled to an FPGA 404. The FPGA 404 is responsible for scheduling, modulation and clock generation. Data which has been received on the physical layer by the Ethernet PHY 403 is passed on separately as I and Q components to a digital/analogue converter 410 and converted into corresponding analogue signals. After renewed filtering through a first deep-pass filter 411a-b, the thus-generated analogue signals are converted into a modulated transmission signal at an I/Q modulator 412 with a clock signal provided by the FPGA. After renewed filtering in a first bandpass filter 413 with a pass range of 440+/−30 MHz and common-mode adjustment in a first balun 414, the filtered transmission signal is converted, via a first mixer 415 and a second bandpass filter 416 with a pass range of 5.8 GHz+/−0.75 GHz, into an HF signal in the 5.8 GHz band. The control frequency for the first mixer 415 is generated by the FPGA 404, a first oscillator 430 and a third bandpass filter 431 with a pass range of 2.8625 GHz+/−14 MHz. The HF signal is amplified in a first amplifier 417 and is output to a 5 GHz broadband antenna via the diplexer 408 with a high-pass filter 418.

In receiving operation, a radio signal received by a broadband antenna 409 is applied, via the diplexer 408 and a deep-pass filter 428, to a second amplifier 427 with a low noise amplifier (LNA). The result is filtered in a fourth bandpass filter 426 with a pass range of 2.4 GHz+/−0.085 MHz and is transformed into the intermediate frequency band via a second mixer 425. The control frequency for the second mixer 425 is generated by the FPGA 404, a second oscillator 440 and a fifth bandpass filter 441 with a pass range of 2.4 GHz+/−10 MHz. After adaptation of the signal amplitude has been carried out by a third amplifier 424 with a variable amplification factor with renewed filtering at a sixth bandpass filter 423 with a pass range of 440+/−30 MHz, the receiving signal is demodulated in a quadrature IF demodulator 422, i.e. broken down into I and Q components. Both components are separately deep-pass filtered in a second deep-pass filter 421a-b and digitised in an ADC 420. The digital I and Q components are converted into the original bit sequence in the FPGA 404 and are converted via the Ethernet PHY 403 into a corresponding (analogue) Ethernet signal and output to the data network via the filter 402.

As described in the embodiments of FIGS. 1-4, the contactless transmission coupler 100, 200, 300, 400 transmits data of a wired data network with low latencies and high data throughput with low requirements on the transmission bandwidth. Data on the bit transmission layer (also referred to as physical layer (PHY)) is detected, modulated and transmitted to a receiver as a radio signal in order to be demodulated and converted back into a corresponding physical data signal. In contrast to conventional radio networks in which the transmission takes place on a higher protocol layer (e.g. the Data Link Layer or the Network Layer), the data signal can be transmitted in this manner from one side to the other almost without delay; the contactless transmission coupler 100, 200, 300, 400 is capable of data transmission under a real-time technical requirement. Furthermore, through the transmitter-side detection and modulation of the bits on the physical layer, the transmission can take place close to the theoretical channel capacity, in contrast to conventional methods in which the analogue signal form forms the basis of the transmission.

Although the present invention has been explained using the 100BASE-T Ethernet standard, it is not restricted to this standard or to the family of Ethernet standards, but applies to other network standards including all standards in which digital data can be transmitted on the physical layer of the OSI model.

What is claimed is:

1. A transmitter for a contactless transmission coupler transmitting data of a wired data network, comprising:
an input receiving a data signal;
a converter connected to the input, receiving the data signal from the input, and converting the data signal into a sequence of bits representing a physical layer of a network protocol employed on the wired data network;
a modulator connected to the converter, receiving the sequence of bits from the converter, and modulating a transmission signal with the sequence of bits;
a high-frequency step connected to the modulator, receiving the transmission signal from the modulator, and generating a high-frequency signal by shifting the transmission signal into a high-frequency band; and
an antenna connected to the high-frequency step, receiving the high-frequency signal from the high-frequency step, and emitting the high-frequency signal.

2. A receiver for a contactless transmission coupler transmitting data of a wired data network, comprising:
an antenna receiving a high-frequency signal;
a high-frequency step connected to the antenna, receiving the high-frequency signal from the antenna, and generating a transmission signal by shifting the high-frequency signal into an intermediate frequency band;
a demodulator connected to the high-frequency step, receiving the transmission signal from the high-frequency step, and demodulating the transmission signal into a sequence of bits representing a physical layer of a network protocol employed on the wired data network;
a converter connected to the demodulator, receiving the sequence of bits from the demodulator, and converting the sequence of bits into a digital signal; and
an output connected to the converter, receiving the digital signal from the converter, and outputting the digital signal.

3. A contactless transmission coupler for transceiving data of a wired data network, comprising:
a transmitter including
(a) a network connection receiving a transmitter data signal,
(b) a converter connected to the network connection, receiving the transmitter data signal from the network connection, and converting the transmitter data signal into a transmitter sequence of bits representing a physical layer of a network protocol employed on the wired data network,
(c) a modulator connected to the converter, receiving the transmitter sequence of bits from the converter, and modulating a transmitter transmission signal with the transmitter sequence of bits,
(d) a transmitter high-frequency step connected to the modulator, receiving the transmitter transmission signal from the modulator, and generating a transmitter high-frequency signal by shifting the transmitter transmission signal into a high-frequency band, and
(e) an antenna connected to the transmitter high-frequency step, receiving the transmitter high-frequency signal from the transmitter high-frequency step, and emitting the transmitter high-frequency signal; and
a receiver including
(a) the antenna receiving a receiver high-frequency signal,
(b) a receiver high-frequency step connected to the antenna, receiving the receiver high-frequency signal from the antenna, and generating a receiver transmission signal by shifting the receiver high-frequency signal into an intermediate frequency band,
(c) a demodulator connected to the receiver high-frequency step, receiving the receiver transmission signal from the receiver high-frequency step, and demodulating the receiver transmission signal into a receiver sequence of bits representing the physical layer of the network protocol employed on the wired data network,
(d) the converter connected to the demodulator, receiving the receiver sequence of bits from the demodulator, and converting the receiver sequence of bits into a receiver digital signal, and
(e) the network connection connected to the converter, receiving the receiver digital signal from the converter, and outputting the receiver digital signal.

4. The contactless transmission coupler of claim 3, wherein the wired data network is based on an Ethernet standard

5. The contactless transmission coupler of claim 4, wherein the wired data network is based on the Ethernet standard 100BASE-T.

6. The contactless transmission coupler of claim 3, wherein at least one of the transmitter high-frequency signal and the receiver high-frequency signal is in an ISM frequency band.

7. The contactless transmission coupler of claim 4, wherein the transmitter high-frequency signal is in a first ISM frequency band and the receiver high-frequency signal is in a second ISM frequency band having a frequency different from the first ISM frequency band.

8. The contactless transmission coupler of claim 7, wherein the first ISM frequency band is at 2.4 GHz and the second ISM frequency band is at 5.8 GHz.

9. The contactless transmission coupler of claim 3, wherein a frequency of the transmitter high-frequency signal and a frequency of the receiver high-frequency signal are both adjustable.

10. The contactless transmission coupler of claim 3, wherein a bandwidth of the transmitter high-frequency signal and a bandwidth of the receiver high-frequency signal are both adjustable.

11. The contactless transmission coupler of claim 3, wherein the transmitter and the receiver are capable of a full-duplex operation.

12. The contactless transmission coupler of claim 3, wherein the transmitter and the receiver are capable of data transmission under a real-time technical requirement.

13. The contactless transmission coupler of claim 3, wherein the converter supplies the transmitter sequence of bits to the modulator with a delay shorter than a time required to transmit a data packet or frame of the network protocol.

14. The contactless transmission coupler of claim 3, wherein the modulator coverts a number of bits of the transmitter sequence of bits into a symbol.

15. The contactless transmission coupler of claim 14, wherein the converter supplies the transmitter sequence of bits in a plurality of groups to the modulator.

16. The contactless transmission coupler of claim 15, wherein each group of the plurality of groups has the number of bits and is supplied to the modulator as soon as the number of bits has been received at the converter.

17. The contactless transmission coupler of claim 3, wherein the modulator modulates the transmitter transmission signal with a quadrature amplitude modulation method.

18. The contactless transmission coupler of claim 17, wherein the quadrature amplitude modulation method is 4-QAM, 16-QAM, 64-QAM, or 256-QAM.
